(19) United States
(12) Patent Application Publication
(10) Pub. No.: US 2014/0368853 A1
(43) Pub. Date: Dec. 18, 2014

(54) PRINTING APPARATUS, CONTROL METHOD OF PRINTING APPARATUS, AND STORAGE MEDIUM

(71) Applicant: CANON KABUSHIKI KAISHA, Tokyo (JP)

(72) Inventor: Yuto Sasaki, Kawasaki-shi (JP)

(73) Assignee: CANON KABUSHIKI KAISHA, Tokyo (JP)

(21) Appl. No.: 14/291,859

(22) Filed: May 30, 2014

(30) Foreign Application Priority Data
Jun. 17, 2013 (JP) 2013-126716

(51) Int. Cl. G06K 15/00

(52) U.S. Cl. CPC G06K 15/404
USPC 358/1.13

(57) ABSTRACT

To shift a printing apparatus to a state capable of restarting a post-process according to completion of a job even if the post-process is interrupted by the job, a holding unit holds a job for which a printing request was accepted; a printing unit prints an image on a sheet by executing the held job; a transportation unit transports the image-printed sheet to a post-processing apparatus; a post-processing unit causes the post-processing apparatus to perform the post-process to the sheet; and a control unit executes, when a new job is accepted while the printing apparatus is operating in a mode of casing the post-processing apparatus to perform the post-process to the sheet inserted by a user, the new job before the held job and shifts the printing apparatus to the mode after the new job and before the held job.

### BACKGROUND OF THE INVENTION

1. Field of the Invention

The present invention relates to a printing apparatus, a control method of the printing apparatus, and a storage medium storing a program to perform the control method.

2. Description of the Related Art

Conventionally, there is a printing apparatus which is equipped with a post-processing apparatus of performing a post-process such as stapling or the like. Here, the printing apparatus like this generally has such a constitution that sheets (recording papers) on which images were printed respectively are transported one by one by the printing apparatus itself to the post-processing apparatus, the transported sheets are loaded or stacked on the tray of the post-processing apparatus, and then the post-process is performed to the loaded or stacked sheets.

Besides, Japanese Patent Application Laid-Open No. 2005-206298 describes a printing apparatus which performs stapling to sheets inserted by a user to a process tray of a post-processing apparatus. It should be noted that such a function of the printing apparatus is called a manual stapling function.

Incidentally, as a timing of executing the manual stapling function, it is possible to set a timing when the sheet is detected by a paper-sheaf detection sensor, instead of a timing when a stapling button is depressed. For example, Japanese Patent Application Laid-Open No. 2005-107322 describes a printing apparatus which prepares, as timing of executing the manual stapling function, two timings, i.e., one is a timing when a sheet is detected by a paper-sheaf detection sensor and the other is a timing when a stapling button is depressed, and can change over these two timings.

The use of the manual stapling function resultingly occupies the post-processing apparatus. Therefore, when the sheet on which the image was printed by the printing apparatus is transported to the post-processing apparatus while the operation in a manual stapling mode is being performed, the transported sheet collides with the sheaf of sheets to which the manual stapling is performed, and thus a jam occurs in the post-processing apparatus. To prevent such inconvenience, a process of inhibiting the printing by the printing apparatus while the manual stapling function is being used (i.e., in the manual stapling mode) is necessary. Moreover, a process of not permitting the use of the manual stapling function (i.e., not permitting to shift the printing apparatus to the manual stapling mode) during the printing by the printing apparatus is necessary.

Here, it is assumed that a user A who stands beside the printing apparatus is using the manual stapling function of the printing apparatus for a long time, and, in such a state, a user B who wishes to execute a copy job in small quantity comes near the printing apparatus. In this case, as described above, a job which includes printing such as normal copying, PDL (page description language) printing or the like cannot be performed in the manual stapling mode. Therefore, to execute the copy job including the printing, it is first necessary for the user B who wishes to interrupt the manual stapling and perform the printing to obtain the agreement of the user A who is using the manual stapling function. If the agreement of the user A can be obtained, it is further necessary to once manually release the printing apparatus from the manual stapling mode. However, under such a circumstance, if a job such as a copy job or a printing job has been entered in a printing queue during the manual stapling mode, printing of the job entered in the printing queue is started in the moment that the printing apparatus is released from the manual stapling mode. In that case, the user B who expressly came near the printing apparatus cannot resultingly execute his/her own job until the started printing of the entered job is completed.

### SUMMARY OF THE INVENTION

The present invention has been completed in consideration of such a problem as described above, and an object of the present invention is to provide a printing apparatus which is characterized by comprising: a holding unit configured to hold a job for which a printing request was accepted; a printing unit configured to print an image on a sheet by executing the job held by the holding unit; a transportation unit configured to transport the sheet on which the image was printed by the printing unit, to a post-processing apparatus; a post-processing unit configured to cause the post-processing apparatus to perform a post-process to the sheet; and a control unit configured to, in a case where a new job is accepted while the printing apparatus is operating in a mode of casing the post-processing apparatus to perform the post-process to the sheet inserted by a user, execute the new job before executing the job held by the holding unit, and shift the printing apparatus to the mode after completing the execution of the new job and before executing the job held by the holding unit.

Further features of the present invention will become apparent from the following description of exemplary embodiments with reference to the attached drawings.

### BRIEF DESCRIPTION OF THE DRAWINGS

FIG. 1 is a block diagram for describing a configuration of an image input/output system to which a printing apparatus according to the present invention is applied.

FIG. 2 is a cross-section diagram of the reader unit and the printer unit both illustrated in FIG. 1.

FIG. 3 is a plan view for describing a configuration of the operation unit illustrated in FIG. 1.

FIG. 4 is a perspective view illustrating an outer appearance of the finisher unit illustrated in FIG. 1.

FIG. 5 is a flow chart for describing a control method of the printing apparatus.

FIG. 6 is a flow chart for describing a control method of the printing apparatus.

FIG. 7 is a diagram illustrating an example of a UI (user interface) screen to be displayed on the operation unit.

FIG. 8 is a diagram illustrating an example of the UI screen to be displayed on the operation unit.

FIG. 9 is a diagram illustrating an example of the UI screen to be displayed on the operation unit.

FIG. 10 is a flow chart for describing a control method of the printing apparatus.

### DESCRIPTION OF THE EMBODIMENTS

Hereinafter, preferred embodiments of the present invention will be described with reference to the attached drawings.

<Description of System Configuration>

### First Embodiment

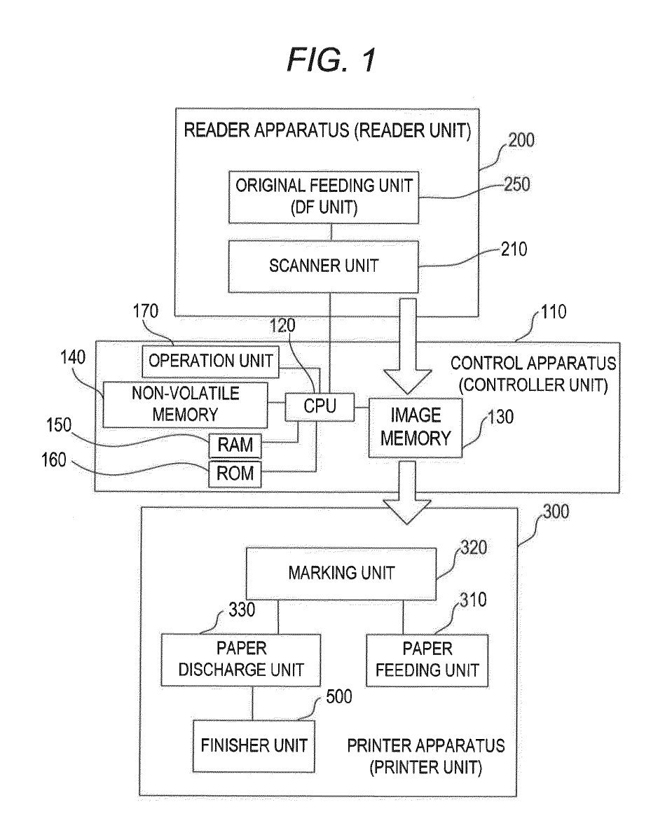

FIG. 1 is a block diagram for describing a configuration of an image input/output system to which a printing apparatus according to the present invention is applied. Incidentally, in the present embodiment, a system in which the printing apparatus has, as job processing units, a printing unit for performing printing on a sheet, a reading unit for reading an original (original copy) and a sheet post-processing unit will be described as an example.

In FIG. 1, a reader unit (image input apparatus) 200 optically reads an original image and thus generates image data. The reader unit 200 is constituted by a scanner unit 210 having a function used for reading an original and an original feeding unit (DF (document feeding) unit) 250 having a function used for transporting originals.

A printer unit (image output apparatus) 300 transports a recording paper (sheet), prints image data on the transported sheet as a visible image, and discharges the image-printed paper to the outside of the printer apparatus. The printer unit 300 is constituted by a paper feeding unit 310 having a plurality kinds of recording paper cassettes, and a marking unit 320 having a function of transferring image data onto the recording paper and fixing the transferred image data as an image. Further, the printer unit 300 is constituted by a paper discharge unit 330 having a function of discharging the print-processed recording paper to the outside of the apparatus, and a finisher unit 500 which performs a stapling process and a sorting process. A control apparatus 110 is constituted by a CPU (central processing unit) 120, an image memory 130, a non-volatile memory 140, a RAM (random access memory) 150, a ROM (read only memory) 160 and an operation unit 170. Incidentally, in the present embodiment, the RAM 150 is used as a holding unit which holds a job accepted in a later-described manual stapling mode. Further, the RAM 150 is used also as a unit which holds information before execution of interruption job (or interrupt job) for determining whether or not to wait for a completion of a sheet post-process before execution of an interruption job. Furthermore, the RAM 150 is used also as a unit which holds information after execution of interruption job for determining whether or not to perform a sheet post-process before a job held in the holding unit, after execution of an interruption job. Incidentally, in the present embodiment, the interruption job is the job by which the manual stapling mode is interrupted and printing is performed.

The control apparatus 110 is electrically connected to the reader unit 200 and the printer unit 300. The CPU 120 in the control apparatus 110 controls the reader unit 200 to read image data of an original into the image memory 130, and further controls the printer unit 300 to output the image data in the image memory 130 onto the recording paper, thereby providing a copy function.

Further, various adjustment values are stored in the non-volatile memory 140, the RAM 150 is used as a working area of the CPU 120, and a control program for the CPU 120 is stored in the ROM 160.

The operation unit 170 is equipped with a liquid crystal display unit, a touch panel sheet attached on the liquid crystal display unit, and a plurality of hard keys. A signal, which was input by use of the touch panel or the hard keys, is transferred to the CPU 120, and the function in an operation of the printing apparatus, image data and the like are displayed on the liquid crystal display unit.

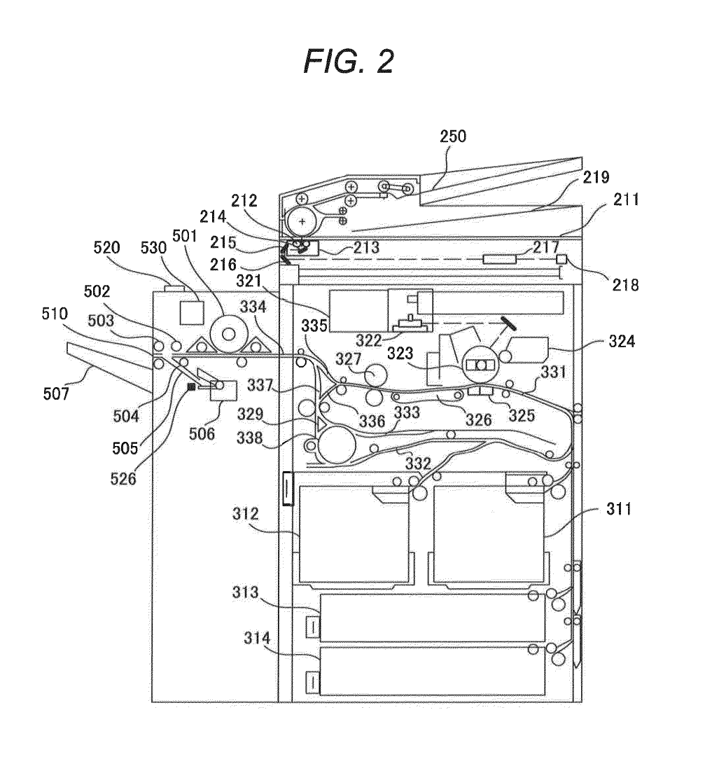

FIG. 2 is a cross-section diagram of the reader unit 200 and the printer unit 300 both illustrated in FIG. 1. First, the reader unit 200 will be described.

In the reader unit 200 illustrated in FIG. 2, the original feeding unit (feeder) 250 feeds originals one by one onto a platen glass 211 in order from the head, and discharges the originals on the platen glass 211 to a paper discharge tray 219 after completing the reading operation of the originals.

When the original is transported on the platen glass 211, a lamp 212 is lit and an optical unit 213 is started to move so that the original is exposed and scanned. Reflected light from the original at this time is guided to a CCD (charge-coupled device) image sensor (simply called a CCD, hereinafter) 218 by mirrors 214, 215 and 216 and a lens 217. In this manner, the image of the scanned original is read by the CCD 218. Then, the image data to be output from the CCD 218 is subjected to a predetermined process and then transferred to the control apparatus 110.

In the printer unit 300, a laser driver 321, which drives a laser beam generation unit 322, causes the laser beam generation unit 322 to generate a laser beam corresponding to the image data output from the control apparatus 110. This laser beam is irradiated to a photosensitive drum 323, and a latent image corresponding to the laser beam is formed on the photosensitive drum 323. A developing agent is applied to the portion of the photosensitive drum 323 corresponding to the formed latent image by a developing unit 324.

Moreover, the printer unit 300 has, as the paper feeding unit 310, cassettes 311, 312, 313 and 314 respectively having drawer-like shapes. The respective paper feeding cassettes are drawn out, and papers are fed to the respective cassettes and then the respective cassettes are closed, thereby performing the paper feeding.

In the printer unit 300, a recording paper is fed from any of the cassettes 311, 312, 313 and 314 and transported to a transfer unit 325 through a transportation path 331. At the transfer unit 325, the developing agent applied to the photosensitive drum 323 is transferred to the recording paper. The recording paper, on which the developing agent has been deposited, is transported to a fixing unit 327 by a transportation belt 326, and the developing agent is fixed on the recording paper by heat and pressure of the fixing unit 327. Thereafter, the recording paper, which passed the fixing unit 327, is discharged through transportation paths 335 and 334. Alternatively, when discharging the recording paper after reversing the print-processed surface, the recording paper is guided to transportation paths 336 and 338, where the recording paper is transported to the reverse direction. Then, the recording paper is transported through a transportation path 337 and the transportation path 334.

In a case where two-sided recording is set, the recording paper is guided to a transportation path 333 from the transportation path 336 by means of a flapper 329 after passing the fixing unit 327, thereafter, the recording paper is transported to the reverse direction and guided to the transportation path 338 and a paper re-feeding transportation path 332 by means of the flapper 329. The recording paper guided to the paper re-feeding transportation path 332 passes through the transportation path 331 with the above timing to be fed to the transfer unit 325. In spite of the one-sided or two-sided recording, the recording paper discharged from the transportation path 334 is transported to the post-processing unit 500.

The transported recording paper is first carried to a buffer unit 501, where the transported recording paper is coiled around the buffer roller for a buffering operation according to a circumstance. For example, in a case where a stapling process or the like to be performed at the downstream side takes much time, transportation speed of the recording paper, which is transported from the main body of the apparatus, can be kept constant by utilizing the buffer unit, and it will be thus possible to become useful for improvement of throughput.

Thereafter, the recording paper is discharged to a paper discharge tray 507 through a paper discharge port 510 by a pair of upstream paper discharge rollers 502 and a pair of downstream paper discharge rollers 503. In case of a stapling mode, the recording paper is pulled back by a roulette belt 504 just after the recording paper was transported by the pair of upstream paper discharge rollers 502 and the trailing edge of the recording paper passed through the pair of the rollers, and the recording paper is then discharged to a stack tray 505.

Then, after that the predetermined number of recording papers were stacked, the stacked recording papers are subjected to a stapling process by a stapling unit 506, and then the processed recording papers are discharged to the paper discharge tray 507 by the pair of downstream paper discharge rollers 503. In case of performing shift sorting, the recording papers stacked on the stack tray are displaced to right and left and discharged to the paper discharge 507, thereby showing differences of the respective sheaves of recording papers.

In the normal stapling, a stapling process is performed after the recording papers discharged from the transportation path 334 were stacked on the stack tray 505. Separately from that stapling process, there is the manual stapling mode, in which a user insets a sheaf of papers in the stack tray 505 and when a paper sheaf detecting sensor 526 detects the sheaf of papers, a stapling process is performed for the sheaf of papers in the stack tray 505 by the stapling unit 506. That is, the manual stapling mode is such a mode of performing the stapling process to the sheets (papers) without performing image printing by the transfer unit 325 and the fixing unit 327. The printing apparatus is shifted to the manual stapling mode by using a manual stapling mode button 520. Further, a human sensor 530 is provided to detect whether or not a human exists in front of the finisher unit 500.

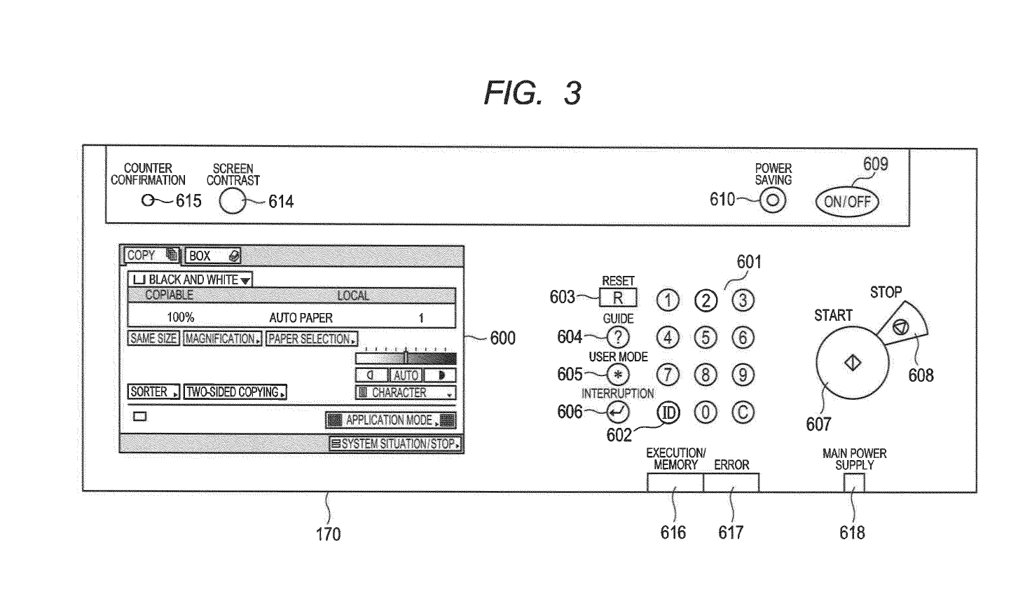

FIG. 3 is a plan view for describing a configuration of the control unit 170 illustrated in FIG. 1.

In FIG. 3, main mode setting and state displaying are performed on an LCD (liquid crystal display) touch panel 600. A numerical keypad 601 is used for inputting numerical values of 0 to 9. An ID (identification) key 602 is used for inputting a section number and a password mode in a case where the apparatus is managed by a section.

A reset key 603 is used for resetting the set mode, a guide key 604 is used for displaying an explanation screen for each mode, a user mode key 605 is used for entering into a user mode screen, and an interruption key 606 is used for interruption copying. Further, a start key 607 is used for starting a copying operation, and a stop key 608 is used for stopping the copy job being executed.

The back light of the LCD 600 is gone out and the apparatus is shifted to a low power state by depression of a soft power supply SW (switch) 609. The apparatus is shifted to a power saving state by depression of a power saving key 610, and the apparatus is recovered from the power saving state by re-depression of the power saving key.

An adjustment key 614 is used for adjusting contrast of the LCD touch panel. A count screen, which displays the sum of the number of copies ever used, is displayed on the LCD by depression of a counter confirmation key 615.

An LED (light-emitting diode) 616 indicates a state of accumulating images in an image memory during a job, an error LED 617 indicates that the apparatus is in an error state such as a jamming state, a door-opened state or the like, and a power supply LED 618 indicates that the main switch of the apparatus is being on.

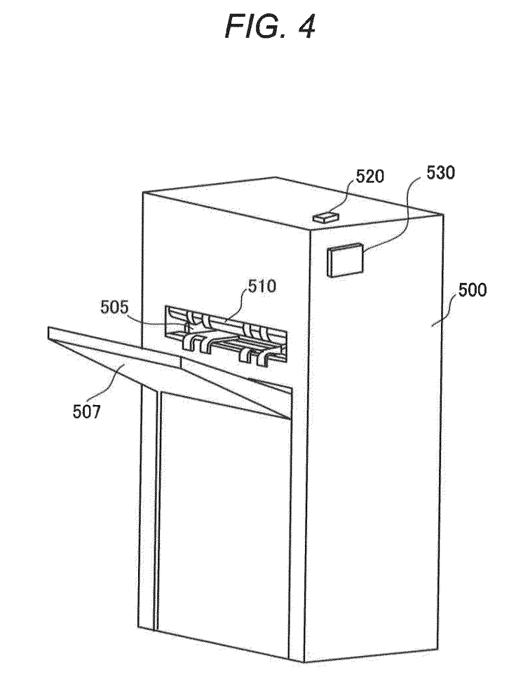

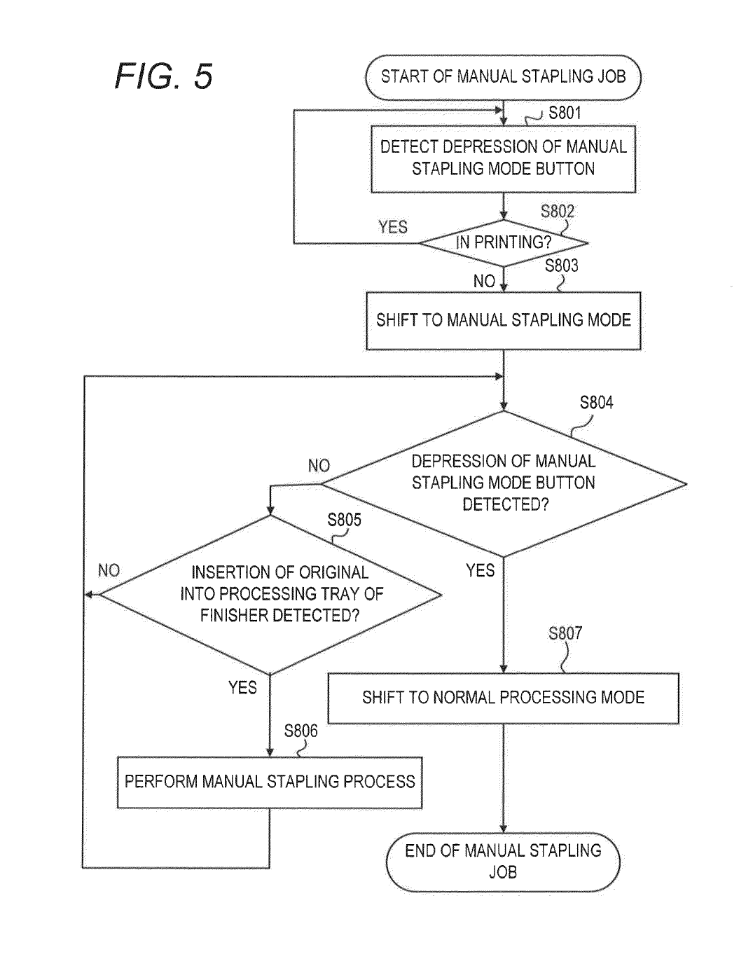

Subsequently, control in the manual stapling mode of the printing apparatus will be described with reference to FIGS. 4 and 5. FIG. 4 is the perspective view illustrating an outer appearance of the finisher unit 500 illustrated in FIG. 1, and FIG. 5 is the flow chart for describing a control method of the printing apparatus according to the present embodiment. Here, it should be noted that the relevant control method corresponds to an example of the process to be performed a manual stapling job. Incidentally, the respective steps in the flow chart are achieved under the condition that the CPU 120 executes the control program stored in the ROM 160 or the like. Hereinafter, the flow of the manual stapling process will be described with reference to FIGS. 4 and 5.

First, it is detected by the CPU 120 that the manual stapling button 520 of the finisher unit 500 is depressed by the user (S801). At this time, it is detected by the CPU 120 whether or not the printing apparatus is in the printing. If it is detected that the printing apparatus is in the printing, the depression of the manual stapling button 520 is disregarded (S802).

The above control is performed because there is a fear that, in the printing, the print-processed papers output from the paper discharge port 501 of the finisher unit 500 collide with the sheaf of papers subjected to the manual stapling process and thus a jam occurs.

On the other hand, if it is detected by the CPU 120 in S802 that the printing apparatus is not in the printing, the CPU 120 shifts the printing apparatus to the manual stapling mode (S803). Thus, in the manual stapling mode, the user can occupy the finisher unit 500 for the purpose of the manual stapling, and thus can dedicate himself/herself to the operation of the manual stapling.

Subsequently, if the depression of the manual stapling button 520 is not detected by the CPU 120 (S804), the process advances to 5805. Then, if it is detected by the paper-sheaf detection sensor 526 that the sheaf of papers is inserted to the stack tray 505 through the paper discharge port 510 (S805), then the CPU 120 causes the stapling unit 506 to perform stapling to the sheaf of papers on the stack tray 505 (S806). Then, the process returns to S804.

On the other hand, in the manual stapling mode, if the depression of the manual stapling button 520 is detected again by the CPU 120 in S804, then the CPU 120 shifts the manual stapling mode to the normal mode (S807), and the process in the flow chart is completed.

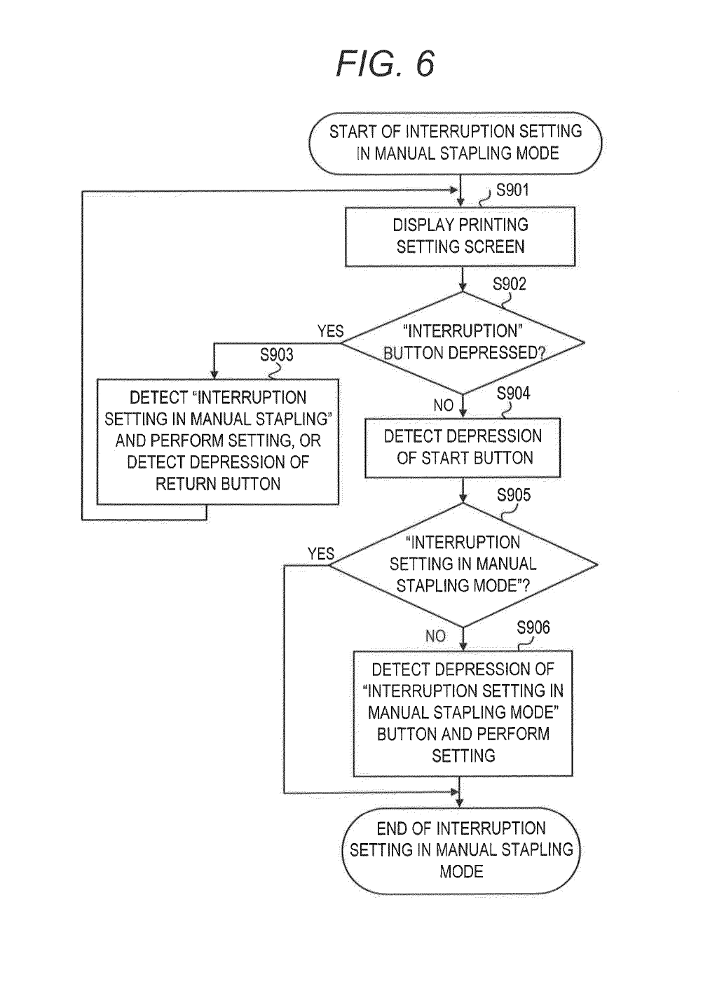

FIG. 6 is a flow chart for describing a control method of the printing apparatus according to the present embodiment. Here, it should be noted that the relevant control method corresponds to an example of an interruption job setting process in the manual stapling mode. Incidentally, the respective steps in the flow chart are achieved under the condition that the CPU 120 executes the control program stored in the ROM 160 or the like.

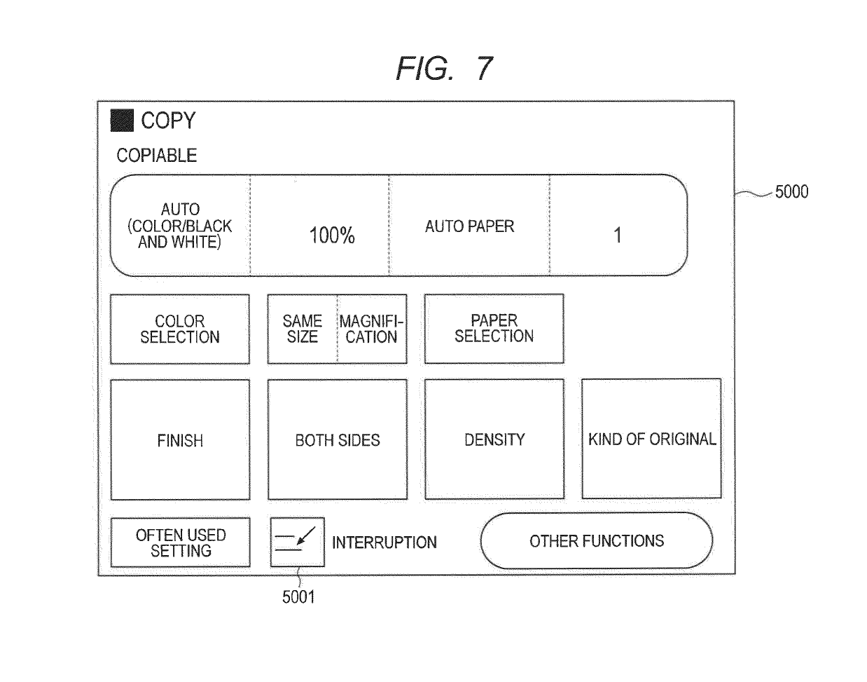

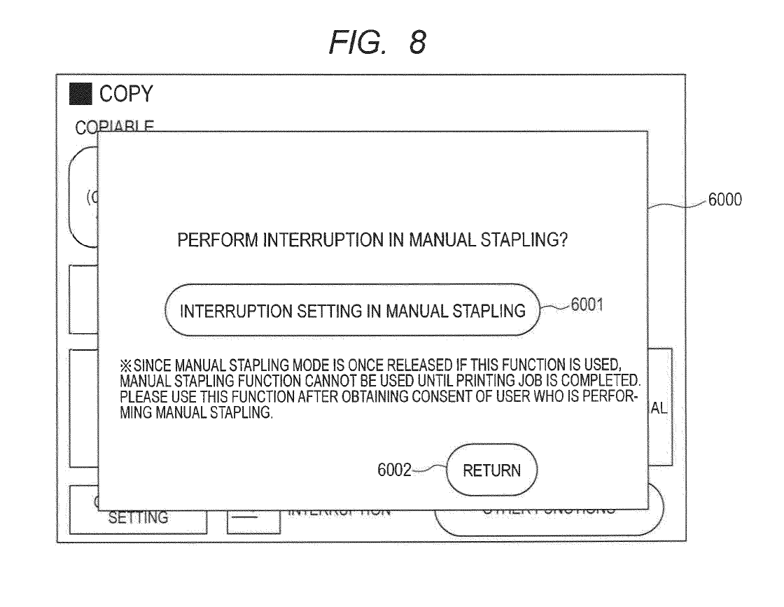

Each of FIGS. 7, 8 and 9 is a diagram illustrating an example of the UI screen to be displayed on the operation unit 170 illustrated in FIG. 1. First, the CPU 120 displays a printing setting screen 5000 illustrated in FIG. 7 on the operation unit 170 (S901). Then, if it is detected by the CPU 120 that an interruption setting button 5001 is depressed by the user (S902), the UI screen illustrated in FIG. 8 is displayed on a pop-up screen 6000. Then, when it is detected by the CPU 120 that an “interruption setting in manual stapling” button 6001 is depressed by the user (S903), the interruption setting in the manual stapling is set in the RAM 150. On that basis, the CPU 120 again displays the printing setting screen 5000 on the operation unit 170 (S901).

On the other hand, if it is detected by the CPU 120 in S902 that a return button 6002 is depressed (S903), the screen directly shifts to the printing setting screen 5000.

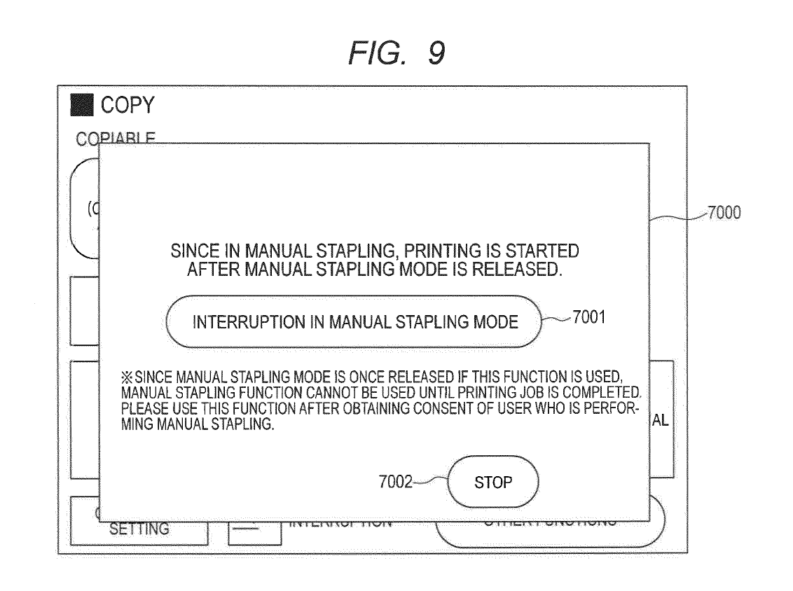

Subsequently, when it is detected by the CPU 120 that the start button 607 is depressed (S904), the CPU accesses the RAM 150 to check whether or not the interruption setting in the manual stapling mode exists (S905). Then, if it is determined by the CPU 120 that the interruption setting in the manual stapling mode exists, the interruption setting in the manual stapling mode is completed. If it is determined that the manual stapling setting is not set at this stage, the CPU 120 displays a pop-up screen 7000 of the UI screen illustrated in FIG. 9 on the operation unit 170.

Here, if it is detected that an interruption button 7001 in the manual stapling mode is depressed, the CPU 120 sets the interruption setting in manual stapling in the RAM 150 (S906), and the interruption setting in the manual stapling mode is completed.

On the other hand, if it is detected by the CPU 120 that a stop button 7002 is depressed by the user on the UI screen illustrated in FIG. 9, then the input printing job is cancelled.

Further, if the user does not perform any action to the pop-up screen 7000, the CPU 120 waits until the manual stapling button 520 is depressed by the user. Then, if it is detected that the manual stapling button is depressed, the CPU starts the printing job.

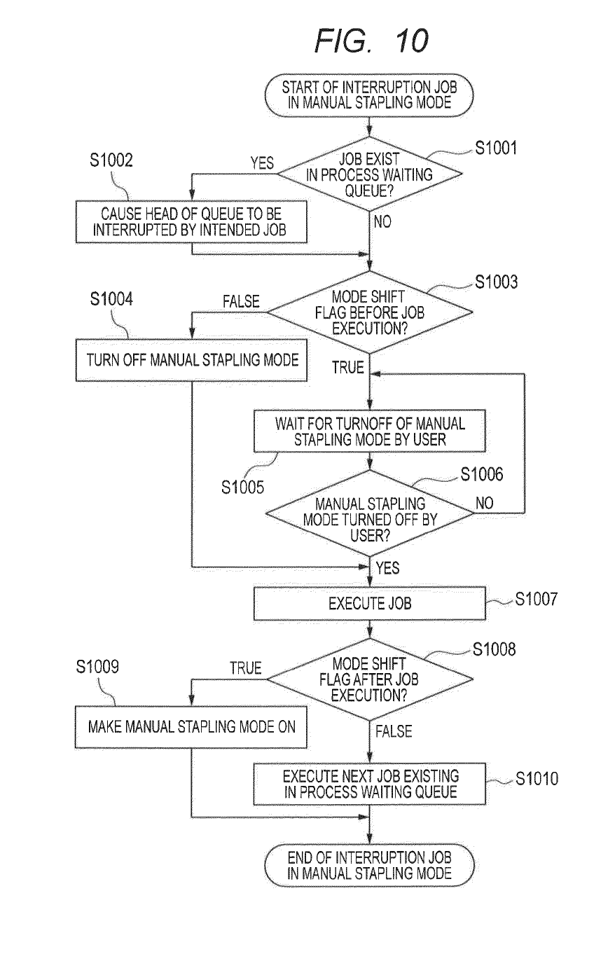

FIG. 10 is a flow chart for describing the control method of the printing apparatus according to the present embodiment. Here, it should be noted that the relevant control method corresponds to an example of the internal process to be performed at the time when the interruption in the manual stapling mode is performed. Incidentally, the respective steps in the flow chart are achieved under the condition that the CPU 120 executes the control program stored in the ROM 160 or the like. Hereinafter, an example that the setting states of later-described different-attribute flag information are determined before the job interruption is started, and the sheet post-process before the execution of the interruption job or the sheet post-process after the completion of the interruption job is controlled will be described. Incidentally, the interruption job in the present embodiment is the job that the manual stapling mode is interrupted and thus the printing is performed.

Here, when describing the following internal process, the attribute held by the interruption job in the manual stapling mode will be first described. More specifically, when it is determined by the CPU 120 that the previously accepted job has been held, the sheet process by the finisher unit 500 is interrupted. Then, the CPU 120 causes to antecedently process the later-accepted interruption job, and, after completing the relevant interruption job, shifts the interrupted sheet process to the state capable of being restarted. Incidentally, the interruption job in the manual stapling mode holds a mode shift flag before job execution and a mode shift flag after job execution of which the values are respectively “FALSE” and “TRUE”. Here, the mode shift flag before job execution (information before interruption job execution) is the flag which is used to shift to the manual stapling mode before execution of the job, whereas the mode shift flag after job execution (information after interruption job execution) is the flag which is used to shift to the manual stapling mode after execution of the job.

First, if the interruption job in the manual stapling mode that interruption by a predetermined job is accepted is input while the post-process to the sheets is being performed, then it is checked by the CPU 120 whether or not another job exists in the process waiting queue in the ROM 160 (S1001). Namely, it is determined by the CPU 120 whether or not the job accepted before the accepted interruption job has been held in the RAM 150.

Then, if it is determined that the job exists in the printing waiting job in the ROM 160, the CPU 120 causes the head of the printing waiting queue to be interrupted by the input interruption job in the manual stapling mode (S1002). Subsequently, the CPU 120 checks the setting state of the input mode shift flag before job execution (S1003).

The CPU 120 checks that the value of the mode shift flag before job execution is “FALSE”, and turns off the manual stapling mode (S1004). Then, the process advances to S1007.

Incidentally, it should be noted that the value of the mode shift flag before job execution is surely “FALSE” in the interruption job in the manual stapling mode. However, if the value of the mode shift flag before job execution is “TRUE”, the CPU 120 waits for release from the manual stapling mode while still maintaining the manual stapling mode (S1005, S1006). More specifically, the CPU 120 waits for the operation that the manual stapling mode is released on the condition that the manual stapling button 520 is depressed by the user.

Then, at the same time when the manual stapling mode is off, the CPU 120 executes the interruption job in the manual stapling mode (S1007).

Subsequently, the CPU 120 checks the setting state of the mode shift flag after job execution corresponding to the job being executed (S1008). More specifically, if the CPU 120 checks that the mode shift flag after job execution in the interruption job in the manual stapling mode is “TRUE”, the CPU automatically returns the printing apparatus to the manual stapling mode according as the job is completed (S1009). Namely, even if there is another job which waits for execution, the CPU 120 shifts the printing apparatus to the manual stapling mode before printing of the relevant another job is executed.

In S1008, it should be noted that the value of the mode shift flag after job execution is surely “TRUE” in the interruption job in the manual stapling mode. However, if it is determined that the value of the mode shift flag after job execution is “FALSE”, the CPU 120 executes a next job existing in the printing waiting queue (S1010), and the process is completed.

Thus, even if the interruption for the job is requested while the printing is being stopped in the manual stapling mode, it is possible to shift the printing apparatus to the state capable of restarting the operation for stapling to the sheets in the manual stapling mode, according to the completion of the relevant job.

More specifically, it is assumed that, while a user A shifted the printing apparatus to the manual stapling mode and is performing the manual stapling, a user B requests the user A to perform copying in small quantity by using the relevant printing apparatus. In this case, according to the present embodiment, in the case where the user A releases the manual stapling mode, the execution-waiting job accepted in the manual stapling mode is not started before the user B starts the copying. Consequently, the copy printing for the user B is not started until the printing for the previously started job is completed, and then the copy job for the user B is preferentially started without keeping the user B waiting. As a result, also the user A who yielded the use of the printing apparatus to the user B does not wait. Therefore, it is possible to adjust the requests of both the user B who requests the interruption job and the user A who performs the sheet process in a balanced manner.

Moreover, the printing apparatus automatically shifts to the manual stapling mode after the job (copy printing job) for the user B is completed and before the printing in another printing job that the user B waits for the execution is started. Therefore, it is possible to resolve the problem of the waiting time for the user A.

As just described, it is possible for the user to shift, in the manual stapling mode, to the mode for performing the printing in the new copy job without executing another printing job in the printing queue. Moreover, it is possible, after the copy job premised on the interruption was completed, to return to the manual stapling mode without executing another printing job in the printing queue.

Incidentally, in the present embodiment, the stapling is described as the example of the sheet process (post-process) to be performed without performing the image printing. However, the example of the sheet process is not limited to the post-process. For example, a punching process of punching the papers (sheets) may be used as the sheet process. Moreover, in the above embodiment, the post-process is performed to the sheaf of papers (sheets) inserted to the stack tray 505. However, the present invention is not limited to this. Namely, it may be possible to perform the post-process to sheets fed from any one of the cassettes 311 to 314 (or a not-illustrated inserter) without printing any image thereon.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment of the present invention, and by a method performed by the computer of the system or apparatus by, for example, reading out and executing the computer executable instructions from the storage medium to perform the functions of one or more of the above-described embodiment. The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blue-ray Disc (BD)™), a flash memory device, a memory card, and the like.

While the present invention has been described with reference to the exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-126716, filed Jun. 17, 2013, which is hereby incorporated by reference herein in its entirety.

What is claimed is:

1. A printing apparatus comprising:
a holding unit configured to hold a job for which a printing request was accepted;
a printing unit configured to print an image on a sheet by executing the job held by the holding unit;
a transportation unit configured to transport the sheet on which the image was printed by the printing unit, to a post-processing apparatus;
a post-processing unit configured to cause the post-processing apparatus to perform a post-process to the sheet; and
a control unit configured to, in a case where a new job is accepted while the printing apparatus is operating in a mode of casing the post-processing apparatus to perform the post-process to the sheet inserted by a user, execute the new job before executing the job held by the holding unit, and shift the printing apparatus to the mode after completing the execution of the new job and before executing the job held by the holding unit.

2. The printing apparatus according to claim 1, wherein the control unit controls to execute the job held by the holding unit, according as the mode of the printing apparatus is released.

3. The printing apparatus according to claim 1, further comprising an accepting unit configured to accept an instruction for shifting the printing apparatus to the mode of casing the post-processing apparatus to perform the post-process to the sheet inserted by the user.

4. The printing apparatus according to claim 1, wherein the mode includes a mode of causing the post-processing apparatus to perform the post-process to the sheet inserted by the user, in a state that the printing by the printing apparatus is restricted.

5. The printing apparatus according to claim 1, wherein the post-process includes a stapling process or a punching process.

6. A printing apparatus comprising:
a holding unit configured to hold a job for which a printing request was accepted;
a printing unit configured to print an image on a sheet by executing the job held by the holding unit;
a transportation unit configured to transport the sheet on which the image was printed by the printing unit, to a post-processing apparatus;
a post-processing unit configured to cause the post-processing apparatus to perform a post-process to the sheet; and
a control unit configured to, in a case where a new job is accepted while the printing apparatus is operating in a mode of casing the post-processing apparatus to perform the post-process to the sheet inserted by a user, control to execute the new job before executing the job held by the holding unit, according as the mode is released.

7. A control method of a printing apparatus, comprising:
holding a job for which a printing request was accepted, in a holding unit;
printing an image on a sheet by executing the job held in the holding unit;
transporting the sheet on which the image was printed to a post-processing apparatus;
causing the post-processing apparatus to perform a post-process to the sheet; and
in a case where a new job is accepted while the printing apparatus is operating in a mode of casing the post-processing apparatus to perform the post-process to the sheet inserted by a user, executing the new job before executing the job held in the holding unit, and shifting the printing apparatus to the mode after completing the execution of the new job and before executing the job held in the holding unit.

8. A non-transitory computer-readable storage medium which stores a program for causing a computer to perform a control method of a printing apparatus, the program comprising:
a code to hold a job for which a printing request was accepted, in a holding unit;
a code to print an image on a sheet by executing the job held in the holding unit;
a code to transport the sheet on which the image was printed to a post-processing apparatus;
a code to cause the post-processing apparatus to perform a post-process to the sheet; and
a code to, in a case where a new job is accepted while the printing apparatus is operating in a mode of casing the post-processing apparatus to perform the post-process to the sheet inserted by a user, execute the new job before executing the job held in the holding unit, and shift the printing apparatus to the mode after completing the execution of the new job and before executing the job held in the holding unit.
